(19) United States
(12) Patent Application Publication
(10) Pub. No.: US 2008/0110544 A1
(43) Pub. Date: May 15, 2008

(54) RUBBER COMPOSITION FOR SIDE WALL AND PNEUMATIC TIRE

(75) Inventor: Norihiko Nakamura, Osaka (JP)

Correspondence Address: FISH & RICHARDSON P.C., P.O. BOX 1022, MINNEAPOLIS, MN, 55440-1022, US

(73) Assignee: TOYO TIRE & RUBBER CO., LTD., Osaka (JP)

(21) Appl. No.: 11/867,320

(22) Filed: Oct. 4, 2007

(30) Foreign Application Priority Data
Nov. 10, 2006 (JP) 2006-305026

(51) Int. Cl. C08L 9/00

(52) U.S. Cl. 152/525; 524/571

(57) ABSTRACT

A rubber composition for a side wall contains 100 parts by weight of a diene rubber component, from 30 to 70 parts by weight of a reinforcing filler, and from 2 to 20 parts by weight of a liquid polymer having a number average molecular weight of from 3,000 to 90,000. A pneumatic tire contains the rubber composition as a side wall of the tire.

### BACKGROUND OF THE INVENTION

1. Field of the Invention

The present invention relates to a rubber composition for a side wall and a pneumatic tire, and more specifically, it relates to a rubber composition for a side wall that is improved in both weather resistance and appearance of a side wall, and a pneumatic tire using the composition.

2. Description of the Related Art

It has been known that as a rubber component of a rubber composition for a side wall of a pneumatic tire, butadiene rubber having a high cis-1,4 bond content (high-cis BR) is mixed with natural rubber for improving cracking resistance. It has also been known that for decreasing fuel consumption of an automobile by decreasing rolling resistance of a tire, hysteresis loss of a side wall of the tire is decreased by changing the colloidal characteristics of carbon black, decreasing the mixing amount of carbon black, or mixing a reinforcing filler other than carbon black, such as silica.

In addition to the rubber component and the filler, an anti-aging agent and wax are generally added to a rubber composition for a side wall in consideration of improvement in weather resistance against formation of cracks and the like due to ozone and an ultraviolet ray. For example, JP-A-10-324779 discloses a rubber composition for a side wall of a tire containing 100 parts by weight of a diene rubber component mixed with from 0.5 to 2.5 parts by weight of wax containing from 3 to 10% by weight of a component having a carbon number of 45 or more and having an average carbon number of from 28 to 38 and from 3.0 to 7.0 parts by weight of an ozone resistant anti-aging agent, which provides a rubber composition for a side wall of a tire that is excellent in ozone resistance and is resistant to discoloration to brown or white.

A rubber composition for a side wall generally contains a softening agent, which is mainly a mineral oil (process oil), in consideration of workability upon kneading, rolling and extruding the rubber composition. At the time when the oil migrates to a rubber composition adjacent to the side wall or to the surface of the side wall, the anti-aging agent and the wax also migrate associated with the oil, whereby consumption of the anti-aging agent and the wax remaining to decrease the amounts of them remaining in the rubber composition. As a result, such a problem arises that the weather resistance cannot be maintained for a prolonged period of time, and the rubber composition suffers discoloration to white or brown.

In order to avoid the problem of migration of the anti-aging agent and wax, the anti-aging agent and wax may be added in larger amounts, but in this case, the anti-aging agent and wax are bloomed in larger amount on the surface of the side wall, causing discoloration to impair the appearance. Accordingly, it has been difficult to attain both weather resistance and appearance in a well-balanced manner.

### SUMMARY OF THE INVENTION

Under the circumstances, an object of the invention is to provide such a pneumatic tire that is improved in both weather resistance and appearance of a side wall by improving a rubber composition for a side wall.

As a result of earnest investigations made by the inventors for attaining the aforementioned and other objects, it has been found that the use of a liquid polymer instead of a process oil, which has been ordinarily used as a softening agent mixed in a rubber composition, appropriately suppresses an anti-aging agent and wax which migrate with the oil in the rubber composition from being bloomed to a surface of a side wall, whereby the cracking resistance and appearance can be improved. Thus, the invention has been completed.

The invention relates to, as one aspect, a rubber composition for a side wall containing 100 parts by weight of a diene rubber component, from 30 to 70 parts by weight of a reinforcing filler, and from 2 to 20 parts by weight of a liquid polymer having a number average molecular weight of from 3,000 to 90,000.

It is preferred in an aspect of the invention that the liquid polymer is a diene liquid polymer.

It is also preferred in an aspect of the invention that the liquid polymer is a functional group-containing liquid polymer having at least one functional group selected from the group consisting of a hydroxyl group, a carboxyl group, an amino group, an epoxy group, an acid anhydride group, a mercapto group and a cyano group at an end of a molecule.

The invention also relates to, as another aspect, a pneumatic tire containing the rubber composition for a side wall of the aspects of the invention as a side wall of the tire.

### BRIEF DESCRIPTION OF THE DRAWING

FIG. 1 is a partial cross sectional view showing a pneumatic tire according to an embodiment of the invention.

### DETAILED DESCRIPTION OF THE INVENTION

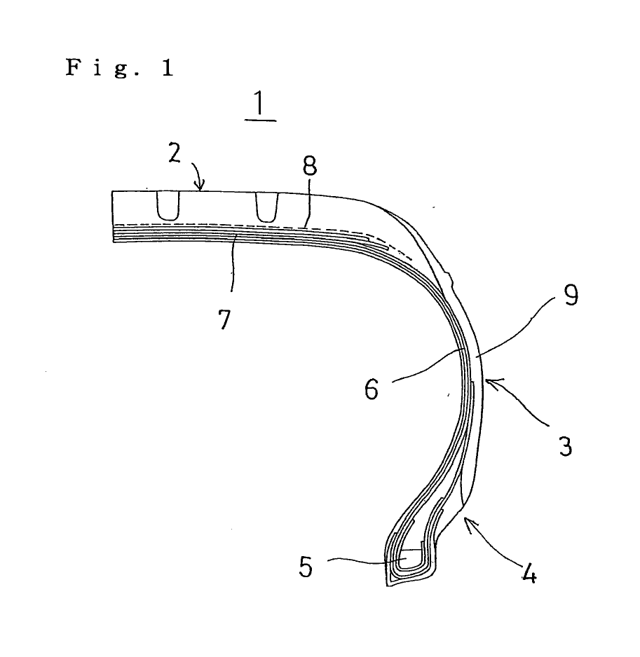

FIG. 1 is a partial cross sectional view showing a pneumatic tire 1 for a passenger automobile according to an embodiment of the invention.

The pneumatic tire 1 (which may be hereinafter simply referred to as a tire) has an ordinary structure containing pair of beads 4 assembled to rims, side walls 3 extending from the beads 4 toward the circumferential direction of the tire, and a tread 2 in contact with a road surface provided between the side walls 3.

The tire 1 is a tire for a passenger automobile having a radial structure containing a carcass 6, a belt 7 and one cap ply 8. The carcass 6 is constituted by one carcass ply formed of organic fiber cords, such as polyester, disposed in the radial direction around a bead core 5 embedded in the bead 4, and is folded and fixed from the inside to the outside of the tire. The belt 7 is constituted by two crossing belt plies formed of steel cords disposed inside the tread 2. The cap ply 8 is formed of organic cords, such as nylon, wound in a helical form with an angle of about 0° with respect to the circumferential direction of the tire, and is disposed outside the belt 7.

Side wall rubber 9 used in the side wall 3 of the tire 1 according to the embodiment of the invention is a rubber composition containing diene rubber as a rubber component with a reinforcing filler, an anti-aging agent and wax, to which a liquid polymer having a number average molecular weight of from 3,000 to 90,000 is added.

The liquid polymer is used instead of a mineral oil (process oil), which has been conventionally mixed as a softening agent, and appropriately suppresses a migration speed of the anti-aging agent and wax to the surface of the side wall rubber 9, whereby the bloomed amount of the anti-aging agent and wax is optimized to improve both the weather resistance and the appearance (discoloration resistance) of the side wall rubber 9.

Examples of the diene rubber in the rubber composition of the invention include various kinds of diene rubber, such as natural rubber (NB), polyisoprene rubber (IR), styrene-butadiene copolymer rubber (SBR), polybutadiene rubber (BR), butadiene rubber containing syndiotactic 1,2-polybutadiene (SPB), a terminal modified low cis BR, isobutylene-isoprene rubber (IIR) (butyl rubber), halogenated butyl rubber, and ethylene-propylene-diene terpolymer rubber (EPDM), which may be used solely or as a mixture of two or more of them.

Preferred examples of the rubber component include a mixture of NB and/or IR, and BR, in which NR and IR ensure the strength of the rubber composition to improve external damage resistance, and BR improves cracking resistance through excellent flexural fatigue resistance thereof. In this case, preferred contents of the components are from 80 to 20% by weight for NR and/or IR and from 20 to 80% by weight for BR, and the content of BR is preferably 20% by weight or more, and more preferably 40% by weight or more. In the case where the content of BR is less than 20% by weight, sufficient cracking resistance may not be obtained. The content of BR is preferably 80% by weight or less, and more preferably 70% by weight or less. In the case where the content of BR exceeds 80% by weight, the external damage resistance may be deteriorated.

BR is preferably high cis BR having a content of cis-1,4 bond of 90% by weight or more since it is advantageous for improving the cracking resistance and for suppressing cracks from growing, and a commercially available product having high versatility can be economically used.

Examples of the reinforcing filler used in the rubber component include carbon black, silica, clay, calcium carbonate, magnesium silicate (talc), and an organic filler, such as a high-styrene resin and a chroman-indene resin. Among these, carbon black and silica are preferred from the standpoint of reinforcing capability and rolling resistance.

The mixing amount of the reinforcing filler is from 30 to 70 parts by weight per 100 parts by weight of the rubber component. In the case where the mixing amount is less than 30 parts by weight, sufficient reinforcing effect of the rubber may not be obtained, and improvement in rubber characteristics through dispersion effect of the filler may not be expected. In the case where the mixing amount exceeds 70 parts by weight, the rubber hardness may be increased, and there may arise a tendency to decrease the dispersion property, which brings about insufficient cracking resistance due to decrease in strength and fatigue resistance due to the dispersion failure.

The carbon black herein is not particularly limited. Examples of the carbon black include carbon black having a nitrogen adsorption specific surface area (N₂SA) of from 25 to 100 m²/g, and specific preferred examples thereof include carbon black of HAF, FEF and GPF classes.

The silica herein is not particularly limited in types thereof. Examples of the silica include wet process silica, dry process silica, colloidal silica and precipitated silica, and wet process silica containing hydrous silicate as a main component is preferably used. The silica is mixed in an amount of from 30 to 70 parts by weight per 100 parts by weight of the rubber component, and in the case where the silica is used in combination with other filler, such as carbon black, the total amount of the filler is from 30 to 70 parts by weight.

For example, the silica is preferably wet process silica having a nitrogen absorption specific surface area (BET) of from 100 to 250 m²/g and a DBP oil absorption amount of 100 mL or more per 100 g from the standpoint of reinforcing effect and workability, and a commercially available product, such as Nipsil AQ and VN3, Tosoh Silica Co., Ltd., and Ultrasil VN3, produced by Degussa AG, may be used. A silane coupling agent, such as bis(triethoxysilylpropyl)tetrasulfide, is preferably used in combination in an amount of from 2 to 20% by weight based on the amount of silica.

An anti-aging agent may be mixed with the rubber component, and examples thereof include anti-aging agents of an amino-ketone series, an aromatic secondary amine series, a phenol series and a benzoimidazole series. Among these, an aromatic secondary amine anti-aging agent and a phenol anti-aging agent are preferred since they are effective against deterioration due to ozone and an ultraviolet ray. Specific examples thereof include N, N′-diphenyl-p-phenylenediamine and N-(1,3-dimethylbutyl)-N′-phenyl-p-phenylenediamine.

Wax may be mixed with the rubber component, and examples thereof include paraffin wax and microcrystalline wax. The wax contains a linear saturated hydrocarbon as a main component, and is liable to migrate within the rubber and be bloomed to the surface. The wax forms a thin film thereof on the surface of the side wall, and ozone and an ultraviolet ray are shielded thereby to suppress cracks, such as ozone cracking, from occurring.

Various kinds of softening agents, such as a vegetable oil softening agent and a mineral oil softening agent, have been conventionally used in consideration of kneadability and workability, such as rolling property and extruding property, of rubber, and a mineral oil (process oil), such as an aromatic oil, a paraffin oil and a naphthene oil, has been mainly used.

A process oil improves workability of rubber but is liable to migrate within rubber, and an anti-aging agent and wax migrate associated with migration of a mineral oil and are bloomed to the surface of the side wall, whereby the large consumption amount thereof brings about deterioration in maintenance of weather resistance and deterioration in appearance due to discoloration.

Under the circumstances, in the invention, a liquid polymer having a number average molecular weight of from 3,000 to 90,000 is used as a softening agent instead of the process oil in an amount of from 2 to 20 parts by weight per 100 parts by weight of the diene rubber component.

The liquid polymer suffers a considerably small migration amount within the rubber composition owing to good compatibility with the rubber component, and does not migrate to the surface of the side wall along with the anti-aging agent and wax. Accordingly, the anti-aging agent and wax are bloomed to the surface of the side wall through their own migration property to maintain an appropriate consumption rate thereof, whereby weather resistance and discoloration resistance are maintained for a prolonged period of time.

In the invention, a process oil is not intentionally mixed as a softening agent, but in the case where a process oil is contained in the rubber composition as an unavoidable component, the amount of the process oil is generally less than 1 part by weight, preferably 0.5 part by weight or less, more preferably 0.2 part by weight or less, and further preferably substantially zero part by weight.

The liquid polymer is a polymer that is in a liquid state at ordinary temperature. In the case where the number average molecular weight is less than 3,000, the migration property of the liquid polymer becomes substantially equivalent to that of a process oil to fail to obtain the effect of improving weather resistance and appearance. In the case where the number average molecular weight exceeds 90,000, favorable workability cannot be obtained due to insufficient softening effect. The number average molecular weight is preferably from 3,000 to 60,000.

The liquid polymer is preferably a diene liquid polymer from the standpoint of improvement in compatibility with the diene rubber component constituting the rubber composition.

Examples of the diene liquid polymer include a butadiene polymer, an isoprene polymer and a styrene-butadiene polymer.

The liquid polymer preferably has an end of molecule that is modified with a functional group having a hetero atom. The modification with a functional group improves compatibility with the filler, such as carbon black and silica, through mutual action with the filler, whereby the dispersibility of the filler is improved to improve the strength and fatigue resistance of the rubber composition, and improvement in weather resistance is also expected owing to the improvement in dispersibility.

Examples of the functional group include a hydroxyl group, a carboxyl group, an amino group, an epoxy group, an acid anhydride group, a mercapto group and a cyano group, which may be used solely or in combination of two or more of them. The hydroxyl group (—OH) herein includes a methylol group (—CH₂OH) and an ethylol group, and also includes a phenol group. Examples of the carboxyl group include groups derived from maleic acid, phthalic acid, acrylic acid and methacrylic acid. The amino group may be a primary amino group, a secondary amino group or a tertiary amino group, and may be an aliphatic amino group or an aromatic amino group. The acid anhydride group is a group derived from an anhydride of a dicarboxylic acid, such as maleic acid and phthalic acid.

The liquid polymer is added in an amount of from 2 to 20 parts by weight per 100 parts by weight of the diene rubber component. In the case where the amount of the liquid polymer is less than 2 parts by weight, the effect of the invention cannot be obtained. In the case where the amount exceeds 20 parts by weight, the dispersibility of the reinforcing filler, such as carbon black, is deteriorated, which brings about deterioration in strength and fatigue resistance.

The rubber composition of the invention may contain depending on necessity mixing components for rubber that are ordinarily used, in addition to the aforementioned components. Examples thereof include stearic acid, zinc oxide, resins, a vulcanizing agent, such as sulfur, a vulcanization accelerator and a vulcanization accelerating assistant, and the mixing ratios thereof are not particularly limited.

The rubber component can be prepared by placing the rubber component and the other mixing components in a kneader, such as a Banbury mixer, followed by kneading the components uniformly, according to the ordinary manner. The resulting rubber composition may be formed into side wall rubber having a prescribed cross sectional shape by using an extruder or the like, and various pneumatic tires, such as a tire for passenger automobile, a large size tire for a truck and a bus, and a tire for a two-wheel vehicle, can be produced by the ordinary manner. In the case where the side wall rubber has a multi-layer structure, such as a two-layer structure, it is sufficient that the rubber composition of the invention is used in at least the outermost layer of the side wall.

### EXAMPLE

The embodiment of the invention will be described in more detail with reference to examples below, but the invention is not construed as being limited thereto.

Rubber components for a side wall were kneaded and prepared according to the formulations (part by weight) shown in Table 1 below by using a Banbury mixer having a capacity of 200 L. The rubber components, the liquid polymers and the mixing components were as shown below.

### Rubber Component

### Natural rubber (NR): RSS #3, made in Thailand

Butadiene rubber (BR): BR150B, produced by Ube Industries, Ltd. (cis-1,4 bond content: 97% by weight)

### Liquid Polymer

Liquid polymer A: liquid polyisoprene, LIR 50, produced by Kuraray Co., Ltd. (no end functional group, number average molecular weight: 50,000)
Liquid polymer B: liquid polybutadiene, CTB2000, produced by Ube Industries, Ltd. (functional group: —COOH, number average molecular weight: 5,000)
Liquid polymer C: liquid polybutadiene, RH-45, produced by Idemitsu Petrochemical, Co., Ltd. (functional group: —OH, number average molecular weight: 2,800)

### Mixing Components

### Carbon black (FEF): Seast SO, produced by Tokai Carbon Co., Ltd.

### Process oil (aromatic oil): X-140, produced by Japan Energy Corp.

### Anti-aging agent (N-(1,3-dimethylbutyl)-N′-phenyl-p-phenylene diamine): Nocrac 6C, produced by Ouchi Shinko Chemical Industrial Co., Ltd.

### Wax (paraffin wax): Ozoace 0355, produced by Nippon Seiro Co., Ltd.

Stearic acid: Lunac S-20, produced by Kao Corp.
Zinc oxide: Zinc White No. 1, produced by Mitsui Mining and Smelting Co., Ltd.

### Sulfur: 5% Oil Processed sulfur, produced by Hosoi Chemical Industry, Co., Ltd.

### Vulcanization accelerator (N-tetrabutyl-2-benzothiazole sulfenamide): Nocceler NS-P, produced by Ouchi Shinko Chemical Industrial Co., Ltd.

The resulting rubber compositions were molded into side wall rubber by extruding with a rubber extruder, and applied to a side wall of a tire for a passenger automobile having a size of 185/70R14 to produce test tires according to the ordinary manner. The test tires thus produced were evaluated for weather resistance and appearance by the following manners. The results obtained are shown in Table 1.

### Weather Resistance

The test tire was installed on a passenger automobile of 1,800 cc displacement, and after running 50,000 km of road, the state of cracking (ozone cracking) on the surface of the side wall was visually observed, and the number, size and depth of cracks were evaluated according to the standard of JIS K6259.

### Appearance

After exposing the test tire to outdoors for 2 months, discoloration of the side wall was visually observed and evaluated for the following three grades.

3: substantially no discoloration observed
2: slight discoloration observed
1: discoloration observed entirely

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Formulation | NR | 40 | 40 | 40 | 40 | 40 | 40 |
| | BR | 60 | 60 | 60 | 60 | 60 | 60 |
| | Liquid polymer A | 10 | — | 10 | — | — | — |
| | Liquid polymer B | — | 10 | — | — | — | — |
| | Liquid polymer C | — | — | — | — | — | 10 |
| | Process oil | — | — | — | 10 | 10 | — |
| | Carbon black | 50 | 50 | 50 | 50 | 50 | 50 |
| | Anti-aging agent | 2 | 2 | 1 | 2 | 4 | 2 |
| | Wax | 2 | 2 | 2 | 2 | 2 | 2 |
| | Stearic acid | 2 | 2 | 2 | 2 | 2 | 2 |
| | Zinc oxide | 3 | 3 | 3 | 3 | 3 | 3 |
| | Sulfur | 2 | 2 | 2 | 2 | 2 | 2 |
| | Vulcanization accelerator | 1.5 | 1.5 | 1.5 | 1.5 | 1.5 | 1.5 |
| Results | Weather resistance | A-2 | A-3 | A-4 | B-4 | A-2 | B-4 |
| | Appearance | 2-3 | 2 | 3 | 2 | 1 | 2 |

It is apparent from Table 1 that, as compared to Comparative Example 1 using a conventional process oil, Examples according to the invention are improved in number of cracks to level A (less number of cracks) and in size of cracks, and exhibit discoloration maintained to a level that is better than or equivalent to Comparative Example 1, and Example 3 using the anti-aging agent in a less amount is suppressed in discoloration and is further improved in appearance.

Comparative Example 2 using the anti-aging agent in an increased amount suffers increased discoloration although it is improved in cracking resistance, and Comparative Example 3 using a liquid polymer having a number average molecular weight of less than 3,000 is not improved in weather resistance and appearance.

A pneumatic tire using the rubber composition for a side wall according to the invention contains the liquid polymer as a softening agent with a mineral oil in a minimized amount, whereby the anti-aging agent and wax are suppressed from being bloomed to the surface of the side wall to attain both weather resistance and appearance, and consumption speed of the anti-aging agent and wax is suppressed to maintain weather resistance even when the mixing amounts thereof are decreased, which contributes to improvement in appearance. Furthermore, the liquid polymer improves the compatibility with the rubber component and the reinforcing filler, whereby the workability is improved or maintained, and the dispersibility of the filler is improved. Accordingly, the rubber composition is improved in strength and fatigue resistance, and thus the cracking resistance of the side wall is further improved.

The invention can be applied to pneumatic tires of various sizes for various purposes, such as a tire for passenger automobile, a large size tire for a truck and a bus, and a tire for a two-wheel vehicle.

1. A rubber composition for a side wall comprising 100 parts by weight of a diene rubber component,
from 30 to 70 parts by weight of a reinforcing filler, and
from 2 to 20 parts by weight of a liquid polymer having a number average molecular weight of from 3,000 to 90,000.

2. The rubber composition for a side wall as claimed in claim 1, wherein the liquid polymer is a diene liquid polymer.

3. The rubber composition for a side wall as claimed in claim 1 or 2, wherein the liquid polymer is a functional group-containing liquid polymer having at least one functional group selected from the group consisting of a hydroxyl group, a carboxyl group, an amino group, an epoxy group, an acid anhydride group, a mercapto group and a cyano group at an end of a molecule.

4. A pneumatic tire comprising the rubber composition for a side wall as claimed in one of claim 1 or 2 as a side wall of the tire.

5. A pneumatic tire comprising the rubber composition for a side wall as claimed in claim 3 as a side wall of the tire.
